(19) United States
(12) Patent Application Publication
(10) Pub. No.: US 2016/0308205 A1
(43) Pub. Date: Oct. 20, 2016

(54) Electrodes for Metal-Ion Batteries

(71) Applicant: NEXEON LIMITED, Oxfordshire (GB)

(72) Inventors: Leigh Canham, Worcestershire (GB); Christopher Michael Friend, Oxon (GB)

(73) Assignee: NEXEON LIMITED, Oxfordshire (GB)

(21) Appl. No.: 15/101,209

(22) PCT Filed: Dec. 3, 2014
(86) PCT No.: PCT/GB2014/053594

§ 371 Date: Jun. 2, 2016

(30) Foreign Application Priority Data
Dec. 3, 2013 (GB) 1321336.8

(51) Int. Cl. H01M 4/38; H01M 4/525; H01M 4/04; H01M 4/134; H01M 4/1395; H01M 10/0525; H01M 4/505

(52) U.S. Cl. CPC H01M 4/386; H01M 10/0525; H01M 4/525; H01M 4/505; H01M 4/134; H01M 4/1395; H01M 4/0471; H01M 4/0404; H01M 2004/027

(57) ABSTRACT

A method is provided for the manufacture of an electrode for a metal-ion battery. The method comprises sintering porous silicon-containing particles at a temperature of 500 to 1200° C. and in an oxygen-free atmosphere to obtain particles of reduced BET surface area which are suitable for use as the active material of a metal ion battery when disposed onto a current collector.

This invention provides a method of fabricating an electrode for a rechargeable metal-ion battery. In particular, the invention relates to a method of fabricating an electrode for a rechargeable metal-ion battery including silicon as an active material. The invention also provides electrodes prepared by the inventive method described herein, and electrochemical batteries comprising the electrodes prepared by the inventive method described herein.

Rechargeable metal-ion batteries are extensively used in portable electronic devices such as mobile telephones and laptops, and are finding increasing application in electric or hybrid electric vehicles. Rechargeable metal-ion batteries have an anode layer, a cathode layer, and an electrolyte between the anode and cathode layers. A porous plastic spacer is typically disposed between the anode and the cathode. The cathode typically comprises a metal current collector provided with a layer of metal ion containing metal-oxide based composite, and the anode typically comprises a metal current collector provided with a layer of a material which is capable of inserting and releasing metal ions. For the avoidance of doubt, the terms “cathode” and “anode” are used herein in the sense that the battery is placed across a load, such that the cathode is the positive electrode and the anode is the negative electrode. When a metal-ion battery is charged, metal ions are transported from the metal-ion-containing cathode layer via the electrolyte to the anode and are inserted into the anode material. As used herein, the term “battery” is used to refer to a device containing a single anode and a single cathode and to devices containing a plurality of anodes and/or cathodes.

There is interest in improving the gravimetric and/or volumetric capacities of rechargeable metal-ion batteries. The use of lithium-ion batteries has already provided a substantial improvement in this regard, but there remains scope for further development. To date, metal-ion batteries have largely been constrained to the use of graphite as an anode material. When a graphite anode is charged, lithium intercalates into the graphite to form a material with the empirical formula LiₓC₆ (wherein x is greater than 0 and less than or equal to 1). Consequently, graphite has a maximum theoretical capacity of 372 mAh/g in a lithium-ions battery, with a practical capacity that is somewhat lower.

Silicon is attracting increasing interest as an alternative to graphite for the manufacture of rechargeable metal-ion batteries having high gravimetric and volumetric capacities because of its high capacity for lithium (see, for example, Insertion Electrode Materials for Rechargeable Lithium Batteries, Winter, M. et al. in Adv. Mater. 1998, 10, No. 10). Silicon has a theoretical capacity in a lithium-ion battery of about 3,600 mAh/g at room temperature (based on Li₁₅Si₄), however its use as an anode material is complicated by large volumetric changes on charging and discharging.

Intercalation of lithium into bulk silicon leads to a massive increase in volume of the anode material (giving a charged volume up to 400% of the uncharged state when silicon is lithiated to its maximum capacity) and repeated charge-discharge cycles are known to cause significant mechanical stress in the silicon material. Fracturing and delamination of silicon results in a loss of electrical contact between the anode material and the current collector, leading to a significant loss of capacity on repeated charge-discharge cycling.

A number of approaches have been proposed to overcome the problems associated with the volume change observed when charging silicon-containing anodes. These relate in general to silicon structures which are better able to tolerate volumetric changes than bulk silicon.

Ohara et al. (Journal of Power Sources 136 (2004) 303-306) have described the evaporation of silicon onto a nickel foil current collector as a thin film and the use of this structure as the anode of a lithium-ion battery. Although this approach gives good capacity retention, the structures do not give useful amounts of capacity per unit area, and increasing the film thickness causes the good capacity retention to be eliminated due to mechanical breakdown as a result of the large volume expansion within the film.

Other approaches relate to the use of silicon structures which include pores or voids which are able to provide a buffer zone for the expansion that is observed when lithium is intercalated into silicon. Examples of silicon structures investigated include arrays of silicon pillars formed on wafers and particles; silicon fibres, rods, tubes or wires; and complete porous particles comprising silicon. For example, U.S. Pat. No. 6,334,939 and U.S. Pat No. 6,514,395 disclose silicon based nanostructures for use as anode materials in lithium ion secondary batteries. Such nanostructures include spherical particles comprising cage-like structures and rods or wires having diameters in the range 1 to 50 nm and lengths in range 500 nm to 10 μm.

US 2009/0253033 discloses an anode material having an inherent porosity for use in lithium-ion secondary batteries. The anode material comprises silicon or silicon alloy particles with dimensions of between 500 nm and 20 μm and a binder or binder precursor. These particles are manufactured using techniques such as vapour deposition, liquid phase deposition or spraying techniques. During anode fabrication, the silicon/binder composite is heat treated to carbonise or partially carbonise the binder component thereby providing the anode with an inherent porosity.

Porous silicon particles are also known and have been investigated for use in lithium-ion batteries. The cost of manufacturing these particles is believed to be less than the cost of manufacturing alternative silicon structures such as silicon fibres, ribbons or pillared particles. For example, US 2009/0186267 discloses an anode material for a lithium-ion battery, the anode material comprising porous silicon particles dispersed in a conductive matrix. The porous silicon particles have a diameter in the range 1 to 10 μm, pore diameters in the range 1 to 100 nm, a BET surface area in the range 140 to 250 m²/g and crystallite sizes in the range 1 to 20 nm. The porous silicon particles are mixed with a conductive material such as carbon black and a binder such as PVDF to form an electrode material which can be applied to a current collector to provide an electrode. However, the life cycle performance of electrodes comprising porous silicon particles needs to be significantly improved before such electrodes could be considered commercially viable.

Jia et al, “Novel Three-Dimensional Mesoporous Silicon for High Power Lithium-Ion Battery Anode Material”, Adv. Energy Mater. 2011, 1, 1036-1039 and Chen et al, “Mesoporous Silicon Anodes Prepared by Magnesiothermic Reduction for Lithium Ion Batteries”, Journal of The Electrochemical Society, 158 (9) A1055-A1059 (2011) disclose formation of mesoporous silicon by magnesiothermic reduction of a silica template.

Hitherto, the focus in this area has been on increasing the porosity of silicon particles so that they are better able to withstand the volumetric changes on repeated cycling. However, high levels of porosity are generally associated with a high BET surface area of the silicon particles, particularly when the porous silicon has been fabricated using known techniques such as reduction of silica and electrochemical or chemical etching processes which produce a plurality of nano-sized pores within the silicon, the small pore sizes further increasing BET surface area. It has been observed by the present inventors that a high BET surface area is disadvantageous for silicon anodes due to the formation of a solid electrolyte interphase (SEI) layer due to reaction of the electrolyte at the anode surface during the first charge-discharge cycle of the battery. The formation of SEI layers consumes significant amounts of lithium and thus depletes the capacity of the battery in subsequent charge-discharge cycles. It has been found that there can be a linear relationship between BET surface area and first cycle loss (FCL) of lithium. Thus, while increased porosity is desirable from the perspective of facilitating expansion of the silicon material during charging and in improving charge rates, a corresponding increase in BET surface area is undesirable due to FCL.

US 2012/0100438 discloses electrode material composite structures comprising a porous silicon particles encapsulated by a shell of a material (such as graphite) that allows the passage of lithium ions but which prevents electrolyte components coming into contact with the encapsulated silicon. While this approach can reduce FCL, the expansion of the encapsulated silicon can place a strain on the graphite shell, leading to fracturing and delamination of the shell and exposure of fresh silicon surface to the electrolyte. Furthermore it can be difficult to achieve a uniform complete shell on every individual particle. In addition, the formation of the encapsulated particles is costly and thus not commercially viable as a replacement for existing metal-ion battery technologies.

There is a need, therefore, for methods of fabricating electrode structures that provide good cycling characteristics, without the problems of FCL due to the formation of SEI layers as outlined above.

Thus, in a first aspect, the present invention provides a method for the manufacture of an electrode for a metal-ion battery, the method comprising:
(i) sintering porous silicon-containing particles at a temperature of 500 to 1200° C. and in an oxygen-free atmosphere; and
(ii) disposing the sintered silicon-containing particles from step (i) onto a current collector.

As used herein, the term “porous particle” shall be understood as referring to a particle comprising a plurality of pores, voids or channels within a particle structure. The term “porous particle” shall also be understood to include a particulate material comprising a random or ordered network of linear, branched or layered elongate elements, wherein one or more discrete or interconnected void spaces or channels are defined between the elongate elements of the network, the elongate elements suitably including linear, branched or layered fibres, tubes, wires, pillars, rods, ribbons, plates or flakes.

For the avoidance of doubt, the term “porous silicon-containing particles” is used herein to refer to the unsintered porous silicon-containing starting material. The term “sintered silicon-containing particles” is used to refer to the material that has been sintered.

The porous silicon-containing particles are preferably mesoporous or microporous silicon-containing particles. As used herein, the term “mesoporous” refers to a particle comprising pores having a diameter in the range of from 2 to 50 nm, and the term “microporous” refers to a particle comprising pores having a diameter of less than 2 nm. The term “macroporous” is used herein to refer to a particle comprising pores having a diameter of greater than 50 nm. Preferably, the porous silicon-containing particles are mesoporous, more preferably the porous silicon-containing particles are mesoporous particles containing pores having a diameter of 30 nm or less, more preferably 20 nm or less, more preferably 10 nm or less.

It has been observed that by sintering porous silicon-containing particles in step (i), the BET surface area of the sintered silicon-containing particles is reduced relative to the starting material without impairing the cycling performance of the silicon-containing particles in a metal-ion battery. Without being bound by theory, it is believed that the sintering process of the present invention is effective to modify the internal pore structure of the porous silicon-containing particles to provide porous particles having improved properties for use in metal-ion batteries. In particular, it is thought that the reduction in BET surface area can be attributed to one or more of: (a) the enlargement of pore size by the coalescence of nanopores into mesopores, and mesopores into larger pores, e.g. macropores; and (b) enclosing pores within the particle volume such that their surfaces are not contacted by the electrolyte. For instance, it is believed that silicon-containing particles having a plurality of pores open to the surface of the particle may in some cases form a “skin” that encloses the internal porous structure of the particles within a substantially continuous external surface. In other cases, it is believed that mesopores and/or micropores may coalesce to form macropores which are open to the surface of the particle but which have a lower exposed surface area than the mesopores and/or micropores in the unsintered porous particles. The method is thus thought to reduce the BET surface area whilst retaining porosity and structural dimensions of the silicon-containing elements within the sintered particles that are similar or substantially the same as those in the porous silicon-containing particles. By maintaining the desired structural dimensions and forms within the sintered particles whilst reducing the BET surface area, the cycling performance can be improved.

The “BET surface area” as used herein should be taken to mean the surface area per unit mass calculated from a measurement of the physical adsorption of gas molecules on a solid surface, using the Brunauer-Emmett-Teller theory. The Barrett-Joyner-Halenda (BJH) theory can also be used to calculate pore volume average pore sizes from the same measurement of gas adsorption. The values for the BET surface area, pore volume and pore sizes calculated from gas adsorption and used herein, do not include the surface area or volume of pores that are fully enclosed with the measured material and not accessible by the gas. The porosity values of starting material and sintered product herein refer to the absolute porosity of the material, including the pore volume of all pores that are both fully and partially enclosed within the bulk of the material.

By retaining the overall porosity of the porous silicon-containing particles, it is observed that the ability of the porous silicon-containing particles to withstand charge-discharge cycling is maintained while reducing FCL compared to the unsintered porous silicon-containing particles. Furthermore, this is obtained at significantly reduced cost compared to the electrode material composite structures disclosed by US 2012/0100438.

A further advantage of the sintering of porous silicon-containing particles in step (i) is that the porous silicon-containing particles are annealed during the heat treatment. This is believed to relieve internal stresses within the porous silicon-containing particles and to repair defects and disclocations of microcrystalline domains, thereby improving the capability of the sintered silicon-containing particles to withstand the strain due to repeated charge-discharge cycling.

Yet a further advantage of the present invention is that the sintering of porous silicon-containing particles in step (i) is thought to result in the rearrangement of silicon atoms at the pore surfaces to low energy {111} and {100} configurations. These surface configurations are particularly beneficial for metal-ion batteries as they are known to have more uniform expansion characteristics.

The porous silicon-containing particles preferably have an initial BET surface area in the range of from 10 to 500 m²/g, for instance from 20 to 400 m²/g, or from 30 to 300 m²/g.

Suitably, at least 50%, preferably at least 70% and more preferably at least 90% of the porous silicon-containing particles have a major particle dimension in the range of from 500 nm to 50 μm. More preferably, at least 50%, more preferably at least 70% and most preferably at least 90% of the porous silicon-containing particles have a major particle dimension in the range of from 1 to 30 μm.

The porous silicon-containing particles preferably have a mass median diameter (D₅₀) in the range of from 500 nm to 50 μm, more preferably in the range of from 1 to 30 μm.

Optionally, at least a portion of the porous silicon-containing particles may be elongate silicon-containing particles. For instance, at least a portion of the silicon-containing particles may have an aspect ratio of at least 3:1, more preferably at least 5:1.

Aspect ratios as described herein are a ratio of largest to smallest external dimensions of a particle. Examples of silicon-containing particles having a high aspect ratio include flakes, and elongate structures such as wires, fibres, rods, tubes and helices. Optionally, at least 10%, at least 20%, at least 30%, at least 40% or at least 50% of the silicon-containing particles may have an aspect ratio as defined above.

In the case of elongate porous silicon-containing particles, the smallest dimension of the porous silicon-containing particles may be less than 15 μm, for example less than 10 μm, less than 3 μm, less than 2 μm, or less than 1 μm. Optionally, the smallest dimension of the porous silicon-containing particles may be less than 800 nm, less than 600 nm, less than 500 nm, less than 400 nm, less than 300 nm, less than 200 nm or less than 100 nm.

The porous silicon-containing particles may be characterised by the presence of a particle microstructure that comprises an interconnected network of elongate structural elements. The elongate structural elements may have an irregular morphology and may be described as acicular, flake-like, dendritic, or coral-like. This particle microstructure is associated with an interconnected network of pores, preferably with a substantially even distribution of the pores throughout the particle. The porous silicon-containing particles preferably comprise networks including structural elements having a high aspect ratio, preferably of at least 3:1 and more preferably at least 5:1. A high aspect ratio of the structural elements provides a high number of interconnections between the structural elements constituting the porous particles for electrical continuity.

The porous silicon-containing particles preferably comprise structural elements having a smallest dimension less than 15 μm, less than 10 μm, less than 3 μm, less than 2 μm, less than 1 μm, less than 300 nm, less than 200 nm, or less than 150 nm, and a largest dimension at least three times, and preferably at least five times the smallest dimension. The smallest dimension is preferably at least 10 nm, more preferably at least 20 nm, and most preferably at least 30 nm.

The porous silicon-containing particles suitably have an initial porosity in the range of from 20 to 80%, preferably from 30 to 70%, and more preferably from 30 to 60%. If the porosity is too low, the sintered silicon-containing particles do not have sufficient cycling capability, whereas if the porosity is too high, the porous structure of the particles can be lost on sintering, again resulting in particles that do not have sufficient cycling capability. Even if the porosity is retained, sintered silicon-particles of very high porosity are not favoured since the porosity reduces the volumetric density of the active material.

The porous silicon-containing particles preferably comprise or consist of microcrystalline or nanocrystalline silicon. Microcrystalline and nanocrystalline silicon is preferred for handling reasons (since fully amorphous silicon is highly reactive in air and easily oxidised which makes storage and handling more problematic) as well as for controlling BET during sintering.

As used herein, the term “porous silicon-containing particles” preferably refers to particles that comprise at least 70% silicon by weight, for example at least 85% silicon by weight, at least 90% silicon by weight, at least 95% silicon by weight, at least 98% silicon by weight or at least 99% silicon by weight. The porous silicon-containing particles may optionally comprise minor amounts of by-products from the preparation of the porous silicon-containing particles, or other components which are not detrimental to the sintering process and/or the subsequent use of the sintered silicon-containing particles in an electrode of a metal-ion battery. Components which may suitably be present in the porous silicon-containing particles also include other materials which have capacity to insert metal ions, such as lithium ions. Examples of such materials include germanium and tin. Alternatively or in addition, the porous silicon-containing particles may comprise a dopant, which may be an n-type or a p-type dopant.

Preferably, the porous silicon-containing particles are substantially free of carbon and do not contain an excess amount of oxygen, silica or silicon oxide. Oxygen may for example be present as a native oxide coating on the silicon surface, or as non-reduced silica or magnesium oxide or calcium oxide by-products from the production of the porous silicon via the reduction of silica. A native silicon oxide coating is typically a coating of oxide no more than a few nm thick (e.g. less than 3 nm) over the silicon surface and the resulting amount of oxygen will depend on the surface area. Preferably, the porous silicon-containing particles contain no more than 5% by weight, preferably no more than 2% by weight, more preferably no more than 1% by weight, and most preferably no more than 0.5% by weight of carbon. Preferably the porous silicon-containing particles contain no more than 30% by weight, preferably no more than 20% by weight and more preferably no more than 10% by weight of oxygen.

The porous silicon-containing particles may in principle be obtained by any known method for the production of porous silicon-containing particles.

One suitable method comprises providing a metal matrix comprising silicon and etching the metal matrix so as to isolate the silicon, for example as disclosed in WO 2010/128310 or WO 2012/028857. A variety of known silicon etching methods can be used to make porous silicon-containing particles containing a plurality of voids/pores and/or elongate structures. The silicon-containing material to be etched may be in the form of a powder of silicon-containing particles or it may be a silicon-containing substrate which is subsequently fragmented after etching to produce the porous particles. Known etching methods include stain etching, electrochemical etching and metal-assisted chemical etching. US 2009/0186267 describes one method of stain etching metallurgical grade silicon powder to produce porous silicon-containing particles.

Another suitable method comprises etching a particle containing silicon so as to obtain a porous silicon-containing particle having a particle core and an array of silicon-containing pillars extending therefrom, for example as disclosed in WO 2009/010758 or WO 2012/175998.

Another suitable method comprises forming a composite material comprising silicon and at least one other element and removing the at least one other element to form pores in the silicon. The pore forming elements may be removed by evaporation, dissolution, etching or thermal treatment.

Another suitable method comprises reducing silica particles in the presence of a suitable metal reducing agent, and preferably in the presence of a metal reducing agent selected from magnesium and calcium, preferably magnesium.

Thus, there is provided a method for the manufacture of an electrode for a metal-ion battery, the method comprising:
(ia) reducing silica-containing particles to provide porous silicon-containing particles;
(ib) sintering the porous silicon-containing particles from step (ia) at a temperature of 500 to 1200° C. and in an oxygen-free atmosphere; and
(ii) disposing the sintered silicon-containing particles from step (ib) onto a current collector.

It will be appreciated that preferred definitions of the porous silicon-containing particles set out above in relation to step (i) are also preferred in relation to the porous silicon-containing particles obtained in step (ia) and used in step (ib).

The reduction of the silica-containing particles in step (ia) is preferably carried out in the presence of a reducing agent selected from a liquid metal or metal vapour. More preferably, the reducing agent is selected from magnesium, aluminium and calcium, and still more preferably the reducing agent is magnesium vapour. Reduction by magnesium is referred to as magnesiothermic reduction and can be illustrated by the following equation (1):

Mg+SiO₂→2MgO+Si (1)

Optionally, at least a portion of the silica-containing particles in step (ia) may be elongate silica-containing particles. For instance, at least a portion of the silica-containing particles may have an aspect ratio of at least 3:1, more preferably at least 5:1.

Optionally, at least 10% of the silica-containing particles of the starting material and/or at least 10% of the particles of the silicon-containing product may have an aspect ratio as described above. Optionally, at least 20%, at least 30%, at least 40% or at least 50% of the particles may have an aspect ratio as defined above.

The silica-containing particles may comprise a network of structural elements including structural elements having a high aspect ratio, preferably of at least 3:1 and more preferably at least 5:1. More preferably, the silica-containing particles comprise structural elements having a smallest dimension less than 15 μm, less than 10 μm, less than 3 μm, less than 2 μm, less than 1 μm, less than 300 nm, less than 200 nm, or less than 150 nm, and a largest dimension at least three times, and preferably at least five times the smallest dimension. The smallest dimension is preferably at least 10 nm, more preferably at least 20 nm, and most preferably at least 30 nm. Examples of silica particles including a network of elongate structural elements are diatoms, spherical silica particles and rice hull ash.

Preferably, either (a) at least a portion of the silica-containing particles are elongate silica-containing particles as described above, or (b) the silica-containing particles comprise elongate structural elements as described above. Optionally, both (a) at least a portion of the silica-containing particles are elongate silica-containing particles and (b) the silica-containing particles comprise elongate structural elements as described above.

The silica-containing particles may optionally comprise structural components that do not have a high aspect ratio and/or dimensions as described above in addition to elements that do have the aforementioned high aspect ratio and dimensions.

It has been found that the shape of the silica-containing particles or silica-containing structural elements may be retained in the porous silicon-containing particles obtained after reduction. Further, the elongate porous silicon-containing particles or particles comprising a network of elongate silicon-containing structural elements thus obtained provide performance improvements as anode materials as described in further detail herein.

Dimensions of particulate starting material or particulate silicon-containing product material may be measured by scanning electron microscopy or TEM. An image of a sample of the particulate material may be divided into a plurality of grid areas, and measurements may be made in randomly selected grid areas in order to determine the percentage of particles of the grid area, and therefore of the larger sample, that possess the dimensions described above. This measurement process may be carried out on one, two or more samples of a particulate material to determine the aforementioned percentage.

In the case of elongate silica-containing particles, the smallest dimension of the silica-containing particles in step (ia) may be less than 15 μm, for example less than 10 μm, less than 3 μm, less than 2 μm, or less than 1 μm. Optionally, the smallest dimension of the silica-containing particles in step (ia) may be less than 800 nm, less than 600 nm, less than 500 nm, less than 400 nm, less than 300 nm, less than 200 nm or less than 100 nm.

Optionally, at least 10% of the silica-containing particles and/or at least 10% porous silicon-containing particles obtained by reduction of the silica-containing particles have a smallest dimension as described above. Optionally, at least 20%, at least 30%, at least 40% or at least 50% of the particles may have a smallest dimension as defined above.

Preferably, the silica-containing particles in step (ia) have a major particle dimension in the range of from 2 to 50 μm, preferably in the range of from 5 to 30 μm.

Preferably, at least 10% of the silica-containing particles and/or at least 10% of the porous silicon-containing particles obtained by reduction of the silica-containing particles have a major particle dimension as described above. Optionally, at least 20%, at least 30%, at least 40%, or at least 50% of the particles have a major particle dimension as defined above.

The silica-containing particles preferably comprise or consist of amorphous silica. Amorphous silica is preferred both for producing the desired porous silicon-containing particles and for safety reasons as handling particulate crystalline silica generally carries greater health and safety risks.

The silica-containing particles may consist essentially of silica, or may contain one or more further aterials. Likewise, the porous silicon-containing particles formed by reduction of the silica-containing particles material may consist essentially of silicon or may contain one or more further materials. Preferably, the silica-containing particles contain at least 50% silica by weight more preferably at least 55% silica by weight, more preferably at least 60% silica by weight. In particular, the silica-containing particles may preferably comprise at least 80% silica by weight, for example at least 85% silica by weight, at least 90% silica by weight, at least 95% silica by weight, at least 98% silica by weight or at least 99% silica by weight.

As above, the porous silicon-containing particles preferably comprise at least 70% silicon by weight, for example at least 85% silicon by weight, at least 90% silicon by weight, at least 95% silicon by weight, at least 98% silicon by weight or at least 99% silicon by weight. While impurities may be present in the porous silicon-containing particles, the porous silicon-containing particles are preferably substantially free of carbon and oxygen, as defined above.

Reduction of impure silica provides a low cost method of producing silicon suitable for use in metal-ion batteries. Optionally, the silica-containing particles are no more than 95% pure by weight, optionally no more than 90 weight % or 80 weight % pure.

The further material or materials may be mixed with the silica-containing particles prior to reduction, or may be impurities in the starting silica. Impurities may be naturally occurring or may be present as a result of a process used to form the starting silica. Impurities present in the silica-containing particles may include one or metals or metal oxides, for example selected from Li, Na, Mg, Zn, Al, Ti, Ca, B or oxides thereof, where each metal oxide is present in amount no more than 20 wt %, or no more than 10 wt % or no more than 5 wt % and the total amount of all metal oxides is no more than 45 wt %. In particular, the silica-containing particles may optionally comprise metal ions such as alkali metal ions, for example lithium ions. Suitably, the metal ions may be present in the form of oxides, such as lithium oxide or sodium oxide. The presence of these further materials may be advantageous in use of the reduced product. For example, the presence of lithium ions may improve performance of a metal ion battery containing silicon produced by reduction of silica containing lithium ions.

The silica-containing particles may optionally contain dopants capable of n- or p-doping the silicon-containing product formed by reduction of the starting material. Dopants may include Al, B, P, Ga, As, Sb, Cu, Au, Ni and Ag. For example, phosphorus-doped silica such as phosphosilicate glass may be used to form the starting particulate silica. More than 50%, more than 80%, more than 90%, more than 95% or more than 99% of the starting material may be silica by weight. Alternatively, or in addition, the silica-containing particles may be exposed to a doping agent during the reduction process in order to form doped silicon. For example, the silica may be exposed to boric acid during reduction to form p-doped silicon. Doping during the reduction process may be particularly preferred if the silica-containing particles do not contain a material for doping of silicon produced by reduction of the starting silica.

Step (ia) may optionally comprise reducing substantially all of the silica in the silica-containing particles to silicon, for example at least 90%, at least 95%, at least 98% or at least 99% of the silica may be reduced to silicon. Alternatively, silica at a surface of the silica-containing particles is reduced and silica at the core of the silica-containing particles is not reduced. For instance, the silica may be reduced up to a depth of 1000 nm, 2000 nm, 3000 nm, 5000 nm or 8000 nm from the surface of the starting material.

If some but not all of the silica-containing particles is to be reduced, then the extent of reduction may be controlled by one or more of reaction time, reaction temperature, starting material thickness, starting silica material porosity, amount of any thermal moderator and the amount of the reducing metal.

Any residual silica in the reduced particles from step (ia) may be removed by treatment with HF or an aqueous metal hydroxide. Thus, in the case where silica at a surface of the silica-containing particles is reduced and silica at a core of the silica-containing particles is not reduced, silica remaining at the core of the reduced particles may be selectively removed by exposure to HF or an aqueous metal hydroxide, such as sodium hydroxide. The use of a metal hydroxide may also remove irregularities from the silicon surface. The material remaining after selective removal of silica is preferably a flake having a hollow core, or a tube. Depending on the length of the starting material and the porosity of the silicon shell, the partially reduced silica may be broken into shorter lengths to allow greater access to the silica core. If the porosity of the silicon shell is high enough, the silica etchant (such as HF) can access the entire silica core without the need to break the reduced material into shorter lengths.

As noted above, the shape of the porous silicon-containing particles from step (ia) is substantially the same as the shape of the silica-containing particles that are reduced. The geometric surface area of the reduced porous silicon-containing particles may be substantially the same as the geometric surface area of the silica-containing particles, or may be larger than the geometric surface area of the silica-containing particles.

The silica-containing particles may optionally comprise a dopant, which may be an n-type or a p-type dopant.

Step (ia) is preferably conducted at a reaction temperature of no more than 750° C., preferably no more than 650° C. Step (ia) is preferably conducted at a reaction temperature of at least 450° C.

The reduction is highly exothermic and thus the local temperature experienced by the reactants may be higher than the set temperature of the reaction vessel. To avoid excessive temperatures, step (ia) is suitably carried out in the presence of a thermal moderator, such as a salt. Preferred thermal moderators have a relatively high specific heat and also a relatively high latent heat of fusion, and preferably should melt at a temperature close to the maximum desired temperature of the reduction reaction. If the reaction approaches the melting temperature of the thermal moderator, melting of the thermal moderator will absorb a significant amount of heat from the reaction, thereby preventing excessive reaction temperatures. Suitable thermal moderators include sodium chloride, potassium chloride and calcium chloride. These materials are soluble in water and thus can readily be dissolved out of the porous silicon product once the reduction is completed in step (ia). The thermal moderator may be mixed with the silica-containing particles and reducing agent, or may be provided as a layer over the silica-containing particles and reducing agent. The molar ratio of starting material : thermal moderator in the reaction mixture is preferably 1:0 to 1:5, and preferably the molar ratio is no more than 1:2.

Step (ia) is preferably conducted in an inert or reducing atmosphere as described above.

Optionally, the silica-containing particles may be reduced by exposure to a reducing composition that causes both reduction of the silica and doping of the silicon.

The elongate silica-containing particles may be obtained from any suitable source of elongate silica structures.

For example, the silica-containing particles may be formed by electrospinning silica. Silica may be electrospun alone or together with a polymer. Electrospinning is described in, for example, Choi et al, J. Mater. Sci. Letters 22, 2003, 891-893, “Silica nanofibres from electrospinning/sol-gel process” and Krissanasaeranee et al, “Preparation of Ultra-Fine Silica Fibers Using Electrospun Poly(Vinyl Alcohol)/Silatrane Composite Fibers as Precursor” J. Am. Ceram. Soc., 91 [9] 2830-2835 (2008), the contents of which are incorporated herein by reference. The properties of the structured silica formed by electrospinning, such as morphology and thickness, may be controlled by the parameters of the electrospinning apparatus and process such as the applied voltage and the distance from the dispenser to the collector. The collector may be shaped to provide a template for moulding the liquid arriving at the collector. For example, the collector may be provided with grooves or other patterning for forming a desired texture at the silica surface.

Another method for synthesising silica is by a sol-gel process. Ma et al, Colloids and Surfaces A: Physicochem. Eng. Aspects 387 (2011) 57-64, “Silver nanoparticles decorated, flexible SiO₂ nanofibers with long-term antibacterial effect as reusable wound cover”, the contents of which are incorporated herein by reference, discloses a method of forming flexible SiO₂ nanofibres without a polymer using SiO₂ fabricated by a sol-gel process.

A yet further method of forming elongate silica-containing particles is vapour-induced solid-liquid-solid growth in which elongate amorphous silica wires are grown from a silicon powder in the presence of oxygen, for example using the method described in Zhang et al, “Vapor-induced solid-liquid-solid process for silicon-based nanowire growth”, Journal of Power Sources 195 (2010) 1691-1697, the contents of which are incorporated herein by reference.

A yet further method of forming elongate silica-containing particles is to draw silica melt through a die. The die may be arranged vertically, and silica melt provided at the top of the die may be drawn through the die under gravity. Other methods for forming silica in a desired shape are sol-gel assembly, templated deposition, microfiber drawing, and chemical vapour deposition (CVD). Elongate silica wires may be twisted or helical, such as the Silica Nanosprings™ made by GoNano Technologies Inc. using a CVD process in tubular flow furnace and having diameters of around 85-200 nm. Silica fibres may be provided as an interconnected porous mat or felt, vertically arranged on substrate or as a plurality of discrete elongate elements.

A further source of elongate silica-containing particles is biogenic silica. Example sources for biogenic silica include specific species of land based plants, marine and freshwater sponges, diatoms or mollusc which extract silicic acid from the soil or seawater, forming intricate silica structures which may be in the form of an open network of fibrils, elongate elements extending outwards form a central core or other structured forms containing elongate elements. Examples of such species include marine sponges, for example tella aspergillum; canary grass; the silica cage of the Venus flower plant; and filamentous thermophile bacteria. Preferably the biogenic silica is derived from land based plants which may offer the most sustainable method of silica fibre production.

Silica fibres can also be synthesized from plant based sources containing high amounts of silica not in a structured form. For example, the production of silica nanowires prepared from rice ash husk is described by Pukird et al. in J. Metals, Materials and Minerals, Vol. 19, pp 33-37, 2009. Silica nanowires with diameters of 40-200 nm and lengths of a few microns were synthesized by thermal evaporation of rice husk ash and coconut shell at 1350° C. in a nitrogen atmosphere.

The porous silicon-containing particles from step (ia) may have a BET surface area that is the same as or greater than the BET surface area of the silica starting material. Preferably, the BET surface area of the porous silicon-containing particles from step (ia) is in the range of from 10 to 500 m²/g, for instance from 200 to 400 m²/g, or from 30 to 300 m²/g.

The reaction parameters in step (ia) may suitably be selected in order to control the BET surface area of the porous silicon-containing particles obtained. Parameters that may affect the BET value of the product include: (a) the dimensions and surface area of the silica-containing particles; (b) the crystallinity of the starting material; (c) the type and amount of impurities in the silica-containing particles; (d) the heat treatment profile during reduction; (e) the ratio of silica-containing particles to reducing metal, for example, the molar ratio of reducing metal to silica (as SiO₂) may be in the range 1.5:1 to 5:1; (f) the ratio of silica-containing particles to thermal moderator; (g) the softening temperature of the silica-containing particles; and (h) the amount of silica or other impurities remaining in the porous silicon-containing particles.

The porous silicon-containing particles from step (ia) may contain reaction by-products, such as magnesium oxide or calcium oxide. Preferably, at least a portion of such by-products is removed prior to step (ib) since they may interfere with the sintering step. Suitably, the reaction by-products, such as magnesium oxide or calcium oxide, may be removed by treatment with HCl.

The present inventors have found that the reduction of silica-containing particles as described herein is far more cost-effective than other methods for the production of porous silicon-containing particles. In particular, the cost of producing silica-containing particles in the form of structured high aspect ratio particles described herein and reducing to porous silicon-containing particles of substantially the same shape and size will typically will typically be much less than the cost of directly producing such silicon particles. Furthermore, other methods to produce the high aspect ratio silicon structures, such as the growth of silicon nanowires using CVD or solid-liquid-solid growth techniques are very difficult to scale up to the production of tonnes of material required that is required.

In some examples, step (ia) may further comprise etching the porous silicon-containing particles to form silicon pillars extending from a silicon core of the porous silicon-containing particles, for example as described in WO 2009/010758 or WO 2012/175998. A suitable etching technique is metal-assisted chemical etching.

As a further option, non-particulate silica-containing material may be pulverised by any known process, for example milling, to form a particulate starting material. For example a silica-based film or membrane formed from a melt or by known deposition methods can be milled to form silica-based flakes.

The aforementioned methods allow formation of structured silica having a shape desired for silicon. By reduction of the starting material using a method that preserves the shape of the silica, the desired structured silicon shape can be obtained with little or no wastage of the starting material.

The silica of the silica-containing particles may be crystalline, polycrystalline, microcrystalline, nanocrystalline or amorphous. Preferably the silica is microcrystalline, nanocrystalline, or amorphous since it is more biocompatible than crystalline or polycrystalline silica and therefore safer to handle. In this respect microcrystalline or nanocrystalline silica means that the silica is comprised from crystalline grains of less than 100 nm, which may be present within an amorphous phase. Polycrystalline shall be taken as meaning that the silica comprises crystalline silica grains of more than 100 nm, for example more than 500 nm, or more than 1 μm. The morphology of the silica source material may be modified to provide a desired morphology of the starting material. The silicon product may be crystalline, polycrystalline, nanocrystalline, microcrystalline or amorphous. Any one of crystalline, polycrystalline, nanocrystalline, microcrystalline and amorphous silica starting material may produce any one of crystalline, polycrystalline, nanocrystalline, microcrystalline and amorphous silicon product. The terms nanocrystalline, microcrystalline and polycrystalline applied to silicon shall take a similar meaning as for silica, i.e. polycrystalline shall mean grain sizes for more than 100 nm and nanocrystalline or microcrystalline shall refer to grain sizes less than 100 nm.

The silica-containing particles may be porous, optionally mesoporous (pore sizes of 2 to 50 nm) or macroporous (pore sizes more than 50 nm), or substantially non-porous.

As noted above, the sintering step is carried out in an oxygen-free atmosphere. The oxygen-free atmosphere may be an inert atmosphere, such as a nitrogen or argon atmosphere. Alternatively, the oxygen-free atmosphere may be a reducing atmosphere, such as a hydrogen-containing atmosphere. For example, pure hydrogen gas, or a mixture of hydrogen and nitrogen may be used as the oxygen-free atmosphere. A reducing atmosphere may be preferred where the porous silicon-containing particles have a native oxide layer on their surface. Typically, a native oxide layer on the surface of silicon has a thickness of 1-2 nm. If a native oxide layer is present, it can inhibit rearrangement of silicon atoms at the silicon surface, thereby limiting the reduction in surface area obtainable by the invention. A hydrogen-containing atmosphere can be used to reduce the native oxide layer during the sintering step.

The method of the invention may optionally comprise the step of pre-treating the porous silicon-containing particles with hydrogen fluoride so as to remove any native oxide layer that is present. Suitably a solution of HF in ethanol/water may be used to remove the native oxide layer prior to sintering.

The sintering is preferably carried out at a temperature of from 600 to 1100° C., more preferably from 800 to 1100° C., more preferably from 850 to 1050° C. and most preferably from 900 to 1000° C.

The sintering is suitably carried out for a duration in the range of from 5 minutes to 24 hours, for example from 10 minutes to 4 hours. For example the sintering may be carried out for a duration of 15 minutes or more, 20 minutes or more, or 30 minutes or more and/or for a duration of 90 minutes or less, 60 minutes or less or 45 minutes or less. In general, the sintering will proceed more quickly at higher temperature, and thus may be substantially complete after 5, 10 15 or 20 minutes at 800° C. or above, whereas lower temperatures may require a sintering duration of 30 minutes or more, 45 minutes or more, or 60 minutes or more.

It will be appreciated that the term “porous silicon-containing particle” as used herein refers to the starting material for the sintering step and defines silicon-containing particles having instrinsic porosity, i.e. pores formed within the structure of each silicon-containing particle.

Preferably, the porous silicon-containing particles are primary particles having intrinsic porosity.

For the avoidance of doubt, the term “primary particle” is used herein in its conventional meaning, i.e. to refer to the individual fragments of matter in a particulate material (IUPAC defines a “primary particle” as the “smallest discrete identifiable entity” in a particulate material). Primary particles may be distinguished from secondary particles, which are particles assembled from a plurality of primary particles and held together either by weak forces of adhesion or cohesion in the case of agglomerates, or by strong atomic or molecular forces in the case of aggregates. The primary particles forming secondary particles retain an individual identity, and it will therefore be understood that secondary particles comprising only pores between the constituent non-porous primary particles can readily be distinguished from primary particles having intrinsic porosity.

The porous silicon-containing particles are preferably discrete primary particles. However, it is not excluded that the porous silicon-containing particles may comprise porous primary particles which are incorporated into secondary particles.

For the avoidance of doubt, the term “sintering” is used herein in a general sense to refer to a heat treatment that results in modification of the structure of the porous silicon-containing particles of the starting material. It is believed that the sintering step may cause atoms to diffuse over the internal and external surfaces of the porous particles from higher energy sites to lower energy sites. It is believed that this may result in sharp surface features being rounded off, thereby reducing BET surface area. However, it is not excluded that there may also be some movement of atoms in the bulk from high energy sites to low energy sites. This latter process may be advantageous since it removes internal stresses within the porous particles and this may contribute to the improved performance observed during intercalation of metal ions and also impede the insertion of metal ions into the bulk of the silicon material.

Following sintering, the sintered silicon-containing particles preferably have a BET surface area of less than 50 m²/g, more preferably less than 40 m²/g, more preferably less than 30 m²/g, more preferably less than 20 m²/g, and most preferably less than 10 m²/g. The sintered silicon-containing particles preferably have a BET surface area of at least 0.1 m²/g, for instance at least 0.2 m²/g, at least 0.5 m²/g, or at least 1.0 m²/g.

The sintering of the porous silicon-containing particles in step (i)/step (ib) preferably reduces the BET surface area of the porous silicon-containing particles by at least 10%, preferably at least 20%, more preferably at least 30%, more preferably at least 40%, and most preferably at least 50%. Optionally, the BET surface area of the sintered silicon-containing particles may be reduced by more than 50%, such as more than 60%, more than 70%, more than 80%, or more than 90% compared to the BET surface area of the porous silicon-containing particles.

Optionally, the sintered silicon-containing particles may undergo further treatment before step (ii). The further treatment may include mixing the sintered product with other materials and/or may include a surface treatment, such as coating with a conductive material (e.g. carbon or metals) or a polymer. The product of these further treatments may have a BET which is lower than the BET of the sintered silicon-containing particles before the further treatment.

Preferably, the BJH average pore size of the sintered silicon-containing particles is at least 40 nm.

Suitably, at least 50%, preferably at least 70% and more preferably at least 90% of the sintered silicon-containing particles have a major particle dimension in the range of from 500 nm to 50 μm. More preferably, at least 50%, more preferably at least 70% and most preferably at least 90% of the sintered silicon-containing particles have a major particle dimension in the range of from 1 to 30 μm.

The sintered silicon-containing particles preferably have a mass median diameter (D₅₀) in the range of from 500 nm to 50 μm, more preferably in the range of from 1 to 30 μm.

Optionally, at least a portion of the sintered silicon-containing particles may be elongate silicon-containing particles. For instance, at least a portion of the sintered silicon-containing particles may have an aspect ratio of at least 3:1, more preferably at least 5:1.

In the case of elongate sintered silicon-containing particles, the smallest dimension of the sintered silicon-containing particles may be less than 15 μm, for example less than 10 μm, less than 3 μm, less than 2 μm, or less than 1 μm. Optionally, the smallest dimension of the sintered silicon-containing particles may be less than 800 nm, less than 600 nm, less than 500 nm, less than 400 nm, less than 300 nm, less than 200 nm or less than 100 nm.

Optionally, at least 10%, at least 20%, at least 30%, at least 40% or at least 50% of the sintered silicon-containing particles may have an aspect ratio as defined above.

The sintered silicon-containing particles may comprise a network of structural elements including structural elements having a high aspect ratio, preferably of at least 3:1 and more preferably at least 5:1. More preferably, the sintered silicon-containing particles comprise structural elements having a smallest dimension less than 15 μm, less than 10 μm, less than 3 μm, less than 2 μm, less than 1 μm, less than 300 nm, less than 200 nm, or less than 150 nm, and a largest dimension at least three times, and preferably at least five times the smallest dimension. The smallest dimension is preferably at least 10 nm, more preferably at least 20 nm, and most preferably at least 30 nm.

The size of the structural elements constituting the sintered silicon-containing particles is an important parameter in relation to the ability of the electroactive material to reversibly intercalate and release metal ions. Structural elements which are too thin may result in excessive first cycle loss due to excessively high BET surface area the resulting formation of an SEI layer. However, structural elements which are too thick are placed under excessive stress during intercalation of metal ions and also impede the insertion of metal ions into the bulk of the silicon material. It is an advantage of the present invention that the dimensions of the structural elements constituting the sintered silicon-containing particles may be substantially unchanged in comparison to the porous silicon-containing particles of the starting material. Thus, the reduction in BET surface area provided by the methods of the present invention is not obtained at the expense of the advantageous properties that may already result from the microstructure of the porous silicon-containing particles of the starting material.

The sintered silicon-containing particles preferably have a porosity in the range of from 20 to 80%, preferably from 20 to 70%, and more preferably from 20 to 60%.

The sintered silicon-containing particles preferably comprise at least 70% silicon by weight, for example at least 85% silicon by weight, at least 90% silicon by weight, at least 95% silicon by weight, at least 98% silicon by weight or at least 99% silicon by weight.

The sintered silicon-containing particles preferably comprise or consist of microcrystalline or nanocrystalline silicon.

As noted above, the sintered silicon-containing particles may comprise an external skin that encloses the internal porous structure of the particles within an external surface. The skin may be continuous (i.e. it has no opening to the internal pores of the particle) or it may be partial. Where an external skin is formed, the thickness of the skin is preferably less than 300 nm, less than 200 nm, or less than 100 nm.

In step (ii) the sintered silicon-containing particles may be disposed onto the current collector by any suitable method of manufacturing electrode coatings. For example, step (ii) may optionally comprise coating a slurry comprising the sintered silicon-containing particles and one or more solvents onto a current collector and removing the solvent to form an anode layer. The slurry preferably comprises a binder material, for example polyimide, polyacrylic acid (PAA) and alkali metal salts thereof, polyvinylalcohol (PVA) and polyvinylidene fluoride (PVDF), sodium carboxymethylcellulose (Na—CMC) and optionally, non-active conductive additives, for example carbon black, carbon fibres, ketjen black or carbon nanotubes.

Optionally, the coating may comprise one or more additional active materials. Exemplary further active materials include active forms of carbon such as graphite or graphene. Active graphite may provide for a larger number of charge/discharge cycles without significant loss of capacity than active silicon, whereas silicon may provide for a higher capacity than graphite. Accordingly, an electrode coating comprising a silicon-containing active material and a graphite active material may provide a lithium ion battery with the advantages of both high capacity and a large number of charge/discharge cycles.

The one or more additional active materials may be coated onto the current collector by a slurry method as described above.

Further treatments may be carried out as required, for example to directly bond the sintered silicon-containing particles to each other and/or to the current collector. Binder material or other coatings may also be applied to the surface of the composite electrode layer after initial formation.

The sintered silicon-containing particles from step (i) or step (ib) may constitute from 1 to 100 wt % of the coating disposed onto the current collector in step (ii). For example the sintered silicon-containing particles may constitute from 2 to 95 wt % of the coating, or from 5 to 90 wt % of the coating. Where the sintered silicon-containing particles are used together with one or more active materials as described above, the sintered silicon-containing particles may suitably constitute from 1 to 80 wt % of the coating, such as from 5 to 60 wt %, or from 10 to 50 wt % of the coating. Where the sintered silicon-containing particles are used without any additional active materials, the sintered silicon-containing particles may constitute from 10 to 100 wt % of the coating, such as from 20 to 99 wt %, or from 50 to 98% by weight of the coating.

Any suitable current collector may be used in the method of the present invention. As used herein, the term current collector refers to any conductive substrate which is capable of carrying a current to and from the sintered silicon-containing particles coated onto the current collector. Examples of materials that can be used as the current collector include copper, aluminium, stainless steel, nickel, titanium and sintered carbon. Copper is a preferred material.

The current collector is typically in the form of a foil or mesh having a thickness of between 3 to 500 μm.

For the avoidance of doubt, the term “major particle dimension” as used herein refers to the maximum distance between a pair of parallel planes tangent to a particle, and the term “largest external dimension shall be understood to have the same meaning. The term “smallest external dimension” as used herein refers to the minimum distance between a pair of parallel planes tangent to a particle.

In another aspect, the present invention provides an electrode obtainable by a method as described above.

In another aspect, the present invention provides a rechargeable metal-ion battery comprising an anode, the anode comprising an electrode obtainable by a method as described above, a cathode comprising a cathode active material capable of releasing and reabsorbing the metal ions; and an electrolyte between the anode and the cathode.

The metal ions are preferably selected from lithium, sodium, potassium, calcium or magnesium. More preferably the rechargeable metal-ion battery of the invention is a lithium-ion battery, and the cathode active material is capable of releasing and lithium ions.

The cathode active material is preferably a metal oxide-based composite. Examples of suitable cathode active materials include LiCoO₂, LiCo_{0.99}Al_{0.01}O₂, LiNiO₂, LiMnO₂, LiCo_{0.5}Ni_{0.5}O₂, LiCo_{0.7}Ni_{0.3}O₂, LiCo_{0.8}Ni_{0.2}O₂, LiCo_{0.82}Ni_{0.18}O₂, LiCo_{0.8}Ni_{0.15}Al_{0.05}O₂, LiNi_{0.4}Co_{0.3}Mn_{0.3}O₂ and LiNi_{0.33}Co_{0.33}Mn_{0.34}O₂. The cathode current collector is generally of a thickness of between 3 to 500 pm. Examples of materials that can be used as the cathode current collector include aluminium, stainless steel, nickel, titanium and sintered carbon.

The electrolyte is suitably a non-aqueous electrolyte containing a metal salt, e.g. a lithium salt, and may include, without limitation, non-aqueous electrolytic solutions, solid electrolytes and inorganic solid electrolytes. Examples of non-aqueous electrolyte solutions that can be used include non-protic organic solvents such as propylene carbonate, ethylene carbonate, butylene carbonates, dimethyl carbonate, diethyl carbonate, gamma butyrolactone, 1,2-dimethoxyethane, 2-methyltetrahydrofuran, dimethylsulphoxide, 1,3-dioxolane, formamide, dimethylformamide, acetonitrile, nitromethane, methylformate, methyl acetate, phosphoric acid triesters, trimethoxymethane, sulpholane, methyl sulpholane and 1,3-dimethyl-2-imidazolidinone.

Examples of organic solid electrolytes include polyethylene derivatives polyethyleneoxide derivatives, polypropylene oxide derivatives, phosphoric acid ester polymers, polyester sulphide, polyvinylalcohols, polyvinylidine fluoride and polymers containing ionic dissociation groups.

Examples of inorganic solid electrolytes include nitrides, halides and sulphides of lithium salts such as Li₅NI₂, Li₃N, Lil, LiSiO₄, Li₂SiS₃, Li₄SiO₄, LiOH and Li₃PO₄.

The lithium salt is suitably soluble in the chosen solvent or mixture of solvents. Examples of suitable lithium salts include LiCl, LiBr, Lil, LiClO₄, LiBF₄, LiBC₄O₈, LiPF₆, LiCF₃SO₃, LiAsF₆, LiSbF₆, LiAlCl₄, CH₃SO₃Li and CF₃SO₃Li.

Where the electrolyte is a non-aqueous organic solution, the battery is preferably provided with a separator interposed between the anode and the cathode. The separator is typically formed of an insulating material having high ion permeability and high mechanical strength. The separator typically has a pore diameter of between 0.01 and 100 μm and a thickness of between 5 and 300 μm. Examples of suitable electrode separators include a micro-porous polyethylene film.

The separator may be replaced by a polymer electrolyte material and in such cases the polymer electrolyte material is present within both the composite anode layer and the composite cathode layer. The polymer electrolyte material can be a solid polymer electrolyte or a gel-type polymer electrolyte.

In another aspect, the present invention provides a method of manufacturing an electrode coating composition, the method comprising:
(i) sintering porous silicon-containing particles at a temperature of 500 to 1200° C. and in an oxygen-free atmosphere; and
(ii) combining the sintered silicon-containing particles from step (i) with a binder and optionally a solvent.

For the avoidance of doubt, the disclosure provided above with reference to preferred porous silicon-containing particles and sintering conditions in connection with the foregoing aspects of the invention is also applicable to this aspect of the invention.

There is also provided a preferred method of manufacturing an electrode coating composition, the method comprising:
(ia) reducing silica-containing particles to provide porous silicon-containing particles;
(ib) sintering the porous silicon-containing particles from step (ia) at a temperature of 500 to 1200° C. and in an oxygen-free atmosphere; and
(ii) combining the sintered silicon-containing particles from step (ib) with a binder and optionally a solvent.

For the avoidance of doubt, the disclosure provided above with reference to preferred porous silica-containing particles and reduction conditions in connection with the foregoing aspects of the invention, is also applicable to this method of the invention.

Suitable binders in accordance with this aspect of the invention include polyimide, polyacrylic acid (PAA) and alkali metal salts thereof, polyvinylalcohol (PVA) and polyvinylidene fluoride (PVDF), sodium carboxymethylcellulose (Na—CMC) and optionally, non-active conductive additives, for example carbon black, carbon fibres, ketjen black or carbon nanotubes.

Optionally, in step (ii) the sintered silicon-containing particles from step (ib) may also be combined with one or more additional active materials. Exemplary further active materials include active forms of carbon such as graphite or graphene.

In a further aspect, the present invention provides an electrode coating composition obtainable by a method as defined above.

In a further aspect, the present invention provides sintered silicon-containing particles obtainable by sintering porous silicon-containing particles as described herein.

In a further aspect, the present invention provides the use of sintered porous silicon-containing particles as an anode active material.

### EXAMPLES

### Example 1

Glass flakes (64-70% silica) with 5-10 μm thickness were reduced to porous silicon flakes using magnesium. The reduction was carried out using a mixture of 17.8 g magnesium and 22.2 g glass flakes on a NaCl bed with a NaCl cap (no additional salt in Mg/glass mix) at 700° C. The reduced flakes were leached with HCl to remove magnesium and salt and then washed with HF (200 ml solution of 40% HF solution per 0.5 g of reduced material) to remove residual silica.

After HCl leaching, the BET surface area of the silica flakes was 29.1 m²/g. After HF washing, the BET rose to 42 m²/g.

The HF washed material was then sintered for two hours at 900° C., 1000° C. and 1100° C. under argon, and the results are shown in Table 1. The pore volumes and average pore sizes quoted in all examples are those calculated using BJH theory from gas adsorption/desorption measurements and measure the characteristics of pores accessible by the gas. These values do not include the pore sizes and volumes of pores that are fully enclosed within the sintered particles and therefore have internal surfaces not accessible to gas or liquid.

TABLE 1

| | | Pore | Average |
|---|---|---|---|
| | BET | volume | pore size |
| Example 1 | (m²/g) | (cm³/g) | (nm) |
| Non-sintered silicon, after HF washing | 42 | 0.0855 | 81.46 |
| Sintering at 900° C. for 2 hours: | 0.44 | 0.00084 | 76.69 |
| Sintering at 1000° C. for 2 hours: | 0.27 | n/a | n/a |
| Sintering at 1100° C. for 2 hours: | 0.18 | n/a | n/a |

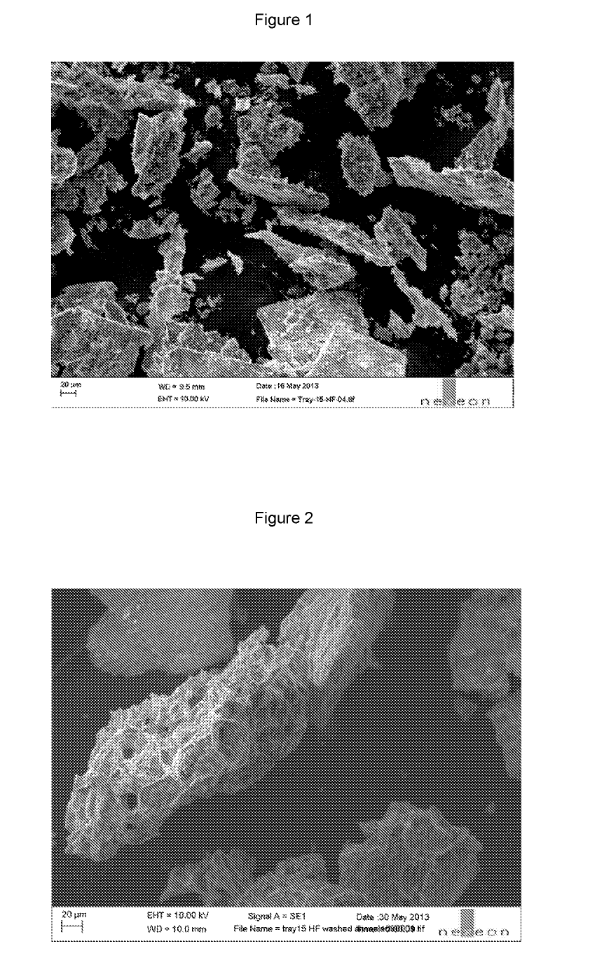

This material underwent a dramatic change in appearance and BET during sintering. FIG. 1 shows the material prior to sintering, and FIG. 2 shows the material obtained after sintering at 900° C.

### Example 2

Glass flakes (64-70% silica) with 5-10 μm thickness were reduced to porous silicon flakes using magnesium. The reduction was carried out using a mixture of 17.8 g magnesium and 22.2 g glass flakes on a NaCl bed with a NaCl cap (no additional salt in Mg/glass mix) at 700° C. The reduced flakes were leached with HCl to remove magnesium and salt and then washed with HF (200 ml solution of 40% HF solution per 0.5 g of reduced material) to remove residual silica.

After HCl leaching, BET surface area of the silica flakes was 153 m²/g. After HF washing, the BET surface area dropped to 14.32 m²/g.

The HF washed material was then sintered for two hours at 800° C. and 900° C. under argon, and the results are shown in Table 2/

TABLE 2

| | | Pore | Average |
|---|---|---|---|
| | BET | volume | pore size |
| Example 2 | (m²/g) | (cm³/g) | (nm) |
| Non-sintered silicon after HF washing | 14.32 | 0.0269 | 102.0 |
| After 800° C. sintering for 2 hours (in Ar) | 11.23 | 0.0210 | 110.5 |
| After 900° C. sintering for 2 hours (in Ar) | 10.14 | 0.0188 | 107.6 |

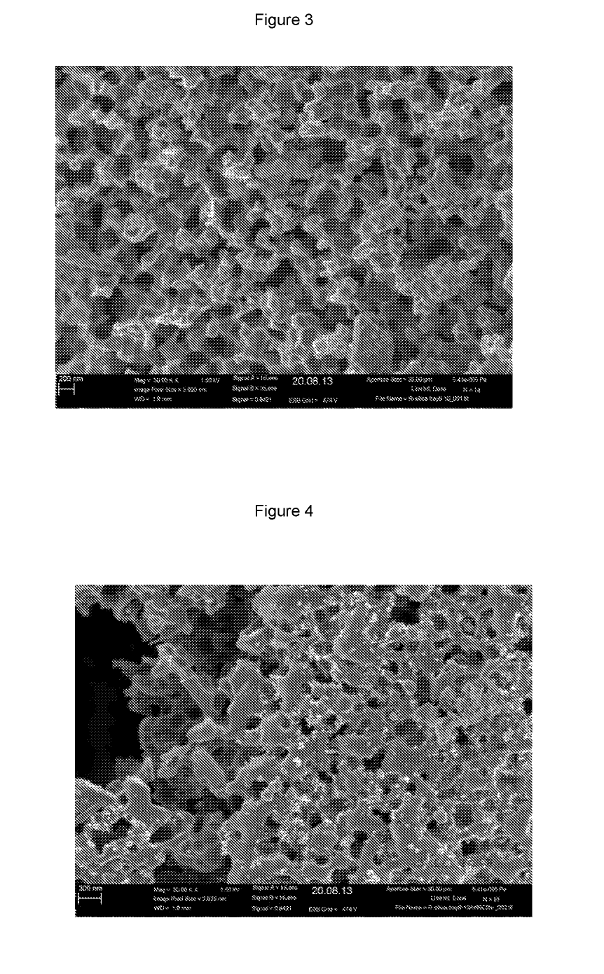

FIG. 3 shows the material prior to sintering, and FIG. 4 shows the material obtained after sintering at 900° C.

### Example 3

Pure silica spheres (solid) with D₅₀=5 μm thickness were reduced to porous silicon spheres and fragments using magnesium. The reduction was carried out using a mixture of 15.6 g magnesium and 19.42 g silica spheres on a NaCl bed with a NaCl cap (no additional salt in Mg/glass mix) at 750° C. The reduced particles (some fragmentation was observed due to the high reduction temperature) were leached with HCl to remove magnesium and salt. An HF washing step was not required.

The reduced material was then sintered for two hours at 850° C. and 900° C. under argon, and the results are shown in Table 3.

TABLE 3

| | | Pore | Average |
|---|---|---|---|
| | BET | volume | pore size |
| Example 3 | (m²/g) | (cm³/g) | (nm) |
| Non-sintered silicon | 14.10 | 0.0361 | 130.0 |
| After 850° C. sintering for 2 hours (in Ar) | 2.95 | 0.0039 | 111.4 |
| After 900° C. sintering for 2 hours (in Ar) | 2.56 | 0.0031 | 83.3 |

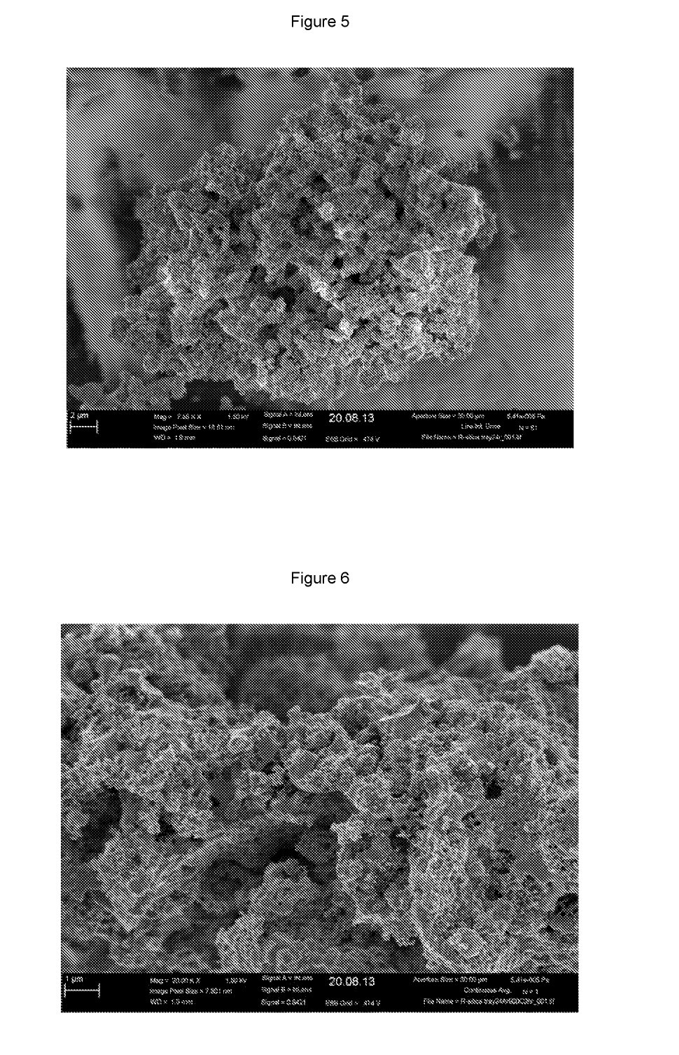

FIG. 5 shows the material prior to sintering, and FIG. 6 shows the material obtained after sintering at 900° C.

### Examples 4 and 5

Porous silicon material having a D₅₀ of 114 μm was obtained by leaching aluminium from Al—Si alloy powder formed by spray atomisation and cooling of a molten alloy containing 12 wt % Si. Leaching was conducted using 3M HCl solution to produce spheroidal porous particles. In Example 5 the particles thus obtained were ball-milled after leaching to produce smaller particle fragments.

This material was sintered for two hours at 850° C. and 900° C. under argon, and the results are shown in Table 4.

TABLE 4

| | | Pore | Average |
|---|---|---|---|
| | BET | volume | pore size |
| | (m²/g) | (cm³/g) | (nm) |
| Example 4 | | | |
| Non-sintered silicon | 23.16 | 0.0283 | 43.72 |
| After 850° C. sintering for 2 hours (in Ar) | 16.44 | 0.0247 | 69.45 |
| After 900° C. sintering for 2 hours (in Ar) | 16.36 | 0.0244 | 70.00 |
| Example 5 | | | |
| Non-sintered silicon | 23.18 | 0.0297 | 49.92 |
| After 800° C. sintering for 2 hours (in Ar) | 15.90 | 0.0233 | 64.03 |
| After 850° C. sintering for 2 hours (in Ar) | 17.00 | 0.0254 | 61.74 |
| After 900° C. sintering for 2 hours (in Ar) | 15.78 | 0.0238 | 66.45 |

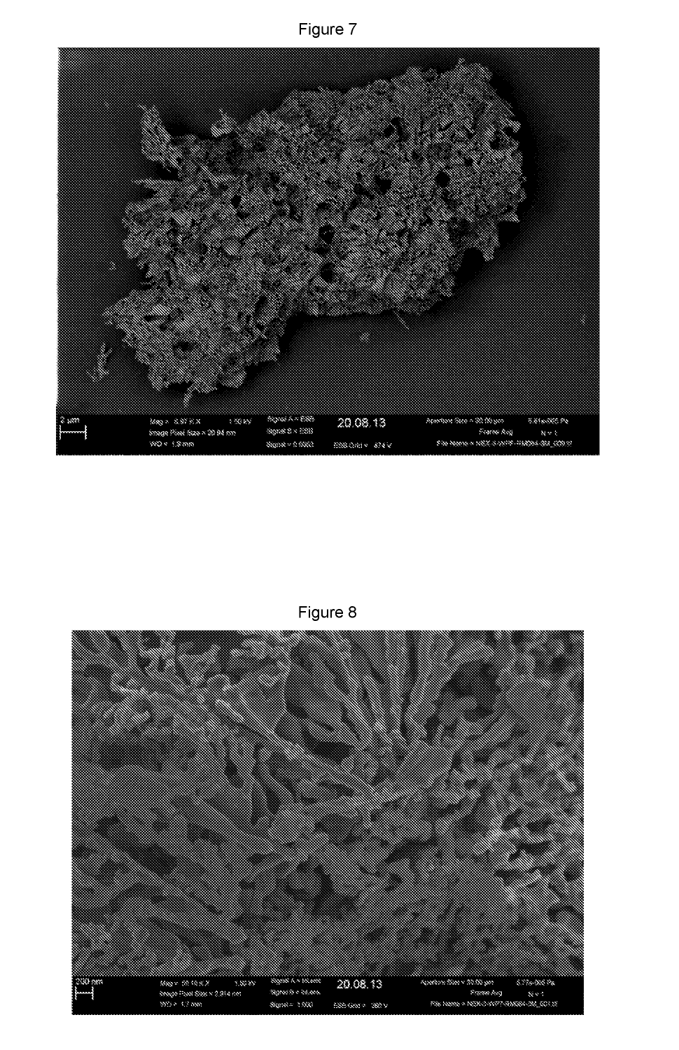

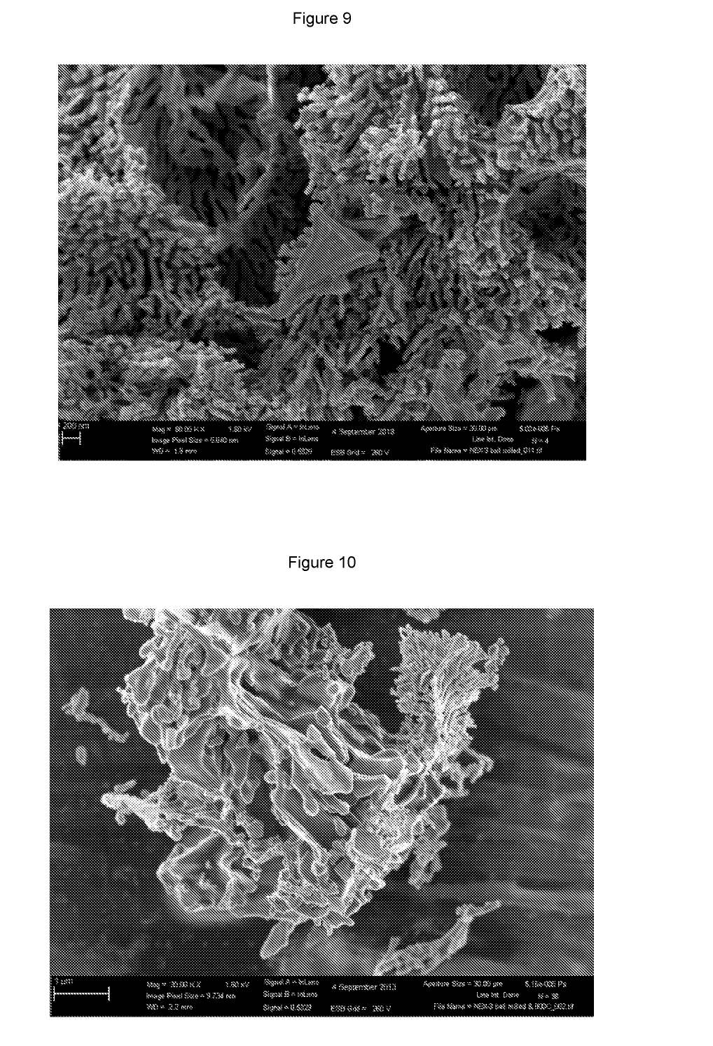

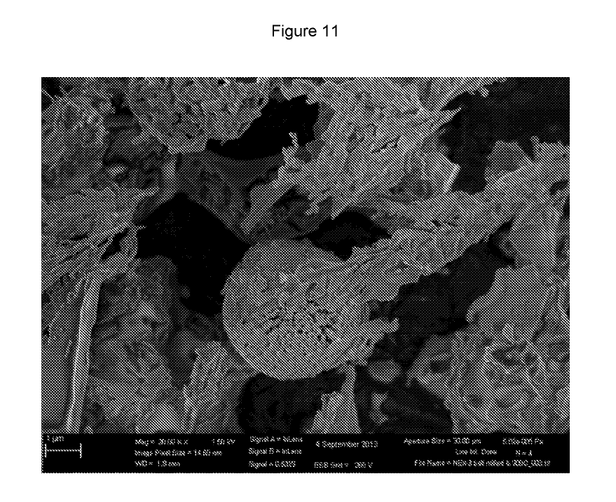

FIG. 7 shows the material of example 5 prior to sintering, and the same material is shown in close up in FIG. 8. FIG. 9 shows the material of example 6 prior to sintering, and FIGS. 10 and 11 show the material obtained after sintering at 800° C. and 900° C., respectively.

1. A method for the manufacture of an electrode for a metal-ion battery, the method comprising:
(i) sintering porous silicon-containing particles at a temperature of 500 to 1200° C. and in an oxygen-free atmosphere; and
(ii) disposing the sintered silicon-containing particles from step (i) onto a current collector.

2. A method according to claim 1, wherein the porous silicon-containing particles are mesoporous or microporous silicon-containing particles.

3. A method according to claim 2, wherein the porous silicon-containing particles are mesoporous silicon-containing particles containing pores having a diameter of 30 nm or less, more preferably 20 nm or less, more preferably 10 nm or less.

4. A method according to any one of the preceding claims, wherein the porous silicon-containing particles preferably have a BET surface area in the range of from 10 to 500 m²/g, preferably from 20 to 400 m²/g, or from 30 to 300 m²/g.

5. A method according to any one of the preceding claims, wherein at least 50%, preferably at least 70% and more preferably at least 90% of the porous silicon-containing particles have a major particle dimension in the range of from 500 nm to 50 μm.

6. A method according to any one of the preceding claims, wherein the porous silicon-containing particles have a mass median diameter (D₅₀) in the range of from 500 nm to 50 μm, more preferably in the range of from 1 to 30 μm.

7. A method according to any one of the preceding claims, wherein the porous silicon-containing particles have a porosity in the range of from 20 to 80%, preferably from 30 to 70%, and more preferably from 30 to 60%.

8. A method according to any one of the preceding claims, wherein the porous silicon-containing particles comprise or consist of microcrystalline or nanocrystalline silicon.

9. A method according to any one of the preceding claims, wherein the porous silicon-containing particles comprise at least 80% silicon by weight, for example at least 85% silicon by weight, at least 90% silicon by weight, at least 95% silicon by weight, at least 98% silicon by weight or at least 99% silicon by weight. cm 10. A method according to any one of the preceding claims, wherein the porous silicon-containing particles comprise no more than 5% by weight, preferably no more than 2% by weight, more preferably no more than 1% by weight, and most preferably no more than 0.5% by weight each of carbon and oxygen.

11. A method according to claim 1, comprising comprising:
(ia) reducing silica-containing particles to provide porous silicon-containing particles;
(ib) sintering the porous silicon-containing particles from step (ia) at a temperature of 500 to 1200° C. and in an oxygen-free atmosphere; and
(ii) disposing the sintered silicon-containing particles from step (ib) onto a current collector.

12. A method according to claim 11, wherein the porous silicon-containing particles are as defined in any one of claims 2 to 10.

13. A method according to claim 11 or claim 12, wherein the silica-containing particles are reduced in step (ia) in the presence of magnesium or calcium, preferably magnesium.

14. A method according to any one of claims 11 to 13, wherein the silica-containing particles in step (ia) comprise elongate silica-containing particles, preferably having an aspect ratio of at least 3:1, more preferably having an aspect ratio of at least 5:1.

15. A method according to any one of claims 11 to 14, wherein the smallest dimension of the silica-containing particles in step (ia) is less than 15 μm, for example less than 10 pm, less than 3 μm, less than 2 μm, or less than 1 μm.

16. A method according to any one of claims 11 to 15, wherein the silica-containing particles in step (ia) have a major particle dimension in the range of from 2 to 50 μm, preferably in the range of from 5 to 30 μm.

17. A method according to any one of claims 11 to 16, wherein the silica-containing particles comprise or consist of amorphous silica.

18. A method according to any one of claims 11 to 17, wherein step (ia) comprises reducing substantially all of the silica in the silica-containing particles to silicon.

19. A method according to any one of claims 11 to 17, wherein step (ia) comprises reducing silica at a surface of the silica-containing particles is reduced and wherein silica at the core of the silica-containing particles is not reduced.

20. A method according any one of claims 11 to 19, wherein residual silica in the porous silicon-containing particles from step (ia) is removed by treatment with HF or an aqueous metal hydroxide.

21. A method according any one of claims 11 to 20, wherein step (ia) is conducted at a reaction temperature of no more than 750° C., preferably no more than 650° C.

22. A method according any one of claims 11 to 21, wherein step (ia) is conducted at a reaction temperature of at least 450° C.

23. A method according any one of claims 11 to 22, wherein the BET surface area of the porous silicon-containing particles from step (ia) is in the range of from 10 to 500 m²/g, preferably from 20 to 400 m²/g, or from 30 to 300 m²/g.

24. A method according to any one of the preceding claims, wherein step (i) or (ib) is carried out in an inert atmosphere or in a reducing atmosphere.

25. A method according to any one of the preceding claims, wherein the porous silicon-containing particles are pre-treated with hydrogen fluoride so as to remove a native oxide layer from the silicon surface prior to step (i) or (ib).

26. A method according to any one of the preceding claims, wherein step (i) or (ib) is carried out at a temperature of from 600 to 1100° C., more preferably from 800 to 1100° C., more preferably from 850 to 1050° C. and most preferably from 900 to 1000° C.

27. A method according to any one of the preceding claims, wherein step (i) or (ib) is carried out for a duration in the range of from 5 minutes to 24 hours, for example from 10 minutes to 4 hours.

28. A method according to any one of the preceding claims, wherein the sintered silicon-containing particles from step (i) or (ib) have a BET surface area of less than 50 m²/g, preferably less than 40 m²/g, more preferably less than 30 m²/g, more preferably less than 20 m²/g, and most preferably less than 10 m²/g.

29. A method according to any one of the preceding claims, wherein the sintered silicon-containing particles from step (i) or (ib) have a BET surface area of at least 0.1 m²/g, preferably at least 0.2 m²/g, at least 0.5 m²/g or at least 1.0 m²/g.

30. A method according to any one of the preceding claims, wherein the sintering of the porous silicon-containing particles in step (i) or (ib) reduces the BET surface area of the porous silicon-containing particles by at least 10%, preferably at least 20%, more preferably at least 30%, more preferably at least 40% and most preferably at least 50%.

31. A method according to any one of the preceding claims, wherein the BJH average pore size of the sintered silicon-containing particles is at least 40 nm.

32. A method according to any one of the preceding claims, wherein wherein at least 50%, preferably at least 70% and more preferably at least 90% of the sintered silicon-containing particles have a major particle dimension in the range of from 500 nm to 50 pm.

33. A method according to any one of the preceding claims, wherein the sintered silicon-containing particles have a mass median diameter (D₅₀) in the range of from 500 nm to 50 μm, more preferably in the range of from 1 to 30 μm.

34. A method according to any one of the preceding claims, wherein the sintered silicon-containing particles have a porosity in the range of from 20 to 80%, preferably from 30 to 70%, and more preferably from 30 to 60%.

35. A method according to any one of the preceding claims, wherein the sintered silicon-containing particles comprise or consist of microcrystalline or nanocrystalline silicon.

36. A method according to any one of the preceding claims, wherein the sintered silicon-containing particles comprise an external skin that encloses the internal porous structure of the particles within an external surface.

37. A method according to any one of the preceding claims, wherein step (ii) comprises coating a slurry comprising the sintered silicon-containing particles and one or more solvents onto a current collector and removing the solvent to form an anode layer.

38. A method according to any one of the preceding claims, wherein the sintered silicon-containing particles from step (i) or step (ib) constitute from 1 to 100 wt %, for example from 2 to 95 wt % or from 5 to 90 wt %, of the coating disposed onto the current collector in step (ii).

39. A method according to any one of the preceding claims, wherein the current collector is in the form of a foil or mesh having a thickness of between 3 to 500 μm.

40. An electrode obtainable by a method as defined in any one of claims 1 to 39.

41. A rechargeable metal-ion battery comprising an anode, the anode comprising an electrode obtainable by a method as defined in any one of claims 1 to 39, a cathode comprising a cathode active material capable of releasing and reabsorbing the metal ions; and an electrolyte between the anode and the cathode.

42. A rechargeable metal-ion battery according to claim 41 which is a lithium-ion battery.

43. A rechargeable metal-ion battery according to claim 41 or claim 42, wherein the cathode active material is selected from LiCoO₂, LiCo_{0.99}Al_{0.01}O₂, LiNiO₂, LiMnO₂, LiCo_{0. 5}Ni_{0. 5}O₂, LiCo_{0.7}Ni_{0.3}O₂, LiCo_{0.8}Ni_{0.2}O₂, LiCo_{0.82}Ni_{0.18}O₂, LiCo_{0.8}Ni_{0.15}Al_{0.05}O₂, LiNi_{0.4}Co_{0.3}Mn_{0.3}O₂ and Li Ni_{0.33}Co_{0.33}Mn_{0.34}O₂.

44. A rechargeable metal-ion battery according to any one of claims 41 to 43, wherein the electrolyte is a non-aqueous electrolyte, an organic solid electrolyte or an inorganic solid electrolyte.

45. A method of manufacturing an electrode coating composition, the method comprising:
(i) sintering porous silicon-containing particles at a temperature of 500to 1200° C. and in an oxygen-free atmosphere; and
(ii) combining the sintered silicon-containing particles from step (i) with a binder and optionally a solvent.

46. A method according to claim 45, comprising comprising:
(ia) reducing silica-containing particles to provide porous silicon-containing particles;
(ib) sintering the porous silicon-containing particles from step (ia) at a temperature of 500 to 1200° C. and in an oxygen-free atmosphere; and
(ii) combining the sintered silicon-containing particles from step (ib) with a binder and optionally a solvent.

47. An electrode coating composition obtainable by a method as defined in claim 45 or claim 46.

48. Sintered silicon-containing particles obtainable by sintering porous silicon-containing particles, wherein the porous silicon-containing particles are as defined in any one of claims 1 to 10 and/or wherein the porous silicon-containing particles are obtainable by reducing silica-containing particles as defined in any one of claims 11 to 23.

49. Sintered silicon-containing particles according to claim 48 obtainable by a sintering method as described in any one of claims 24 to 27.

50. Sintered silicon-containing particles according to claim 48 or claim 49, wherein the sintered silicon-containing particles are as defined in any one of claims 28 to 36.

51. Use of sintered silicon-containing particles as an anode active material.

52. Use according to claim 51, wherein the sintered silicon-containing particles are obtainable by sintering porous silicon-containing particles, wherein the porous silicon-containing particles are as defined in any one of claims 1 to 10 and/or wherein the porous silicon-containing particles are obtainable by reducing silica-containing particles as defined in any one of claims 11 to 23.

53. Use according to claim 51 or claim 52, wherein the sintered silicon-containing particles are obtainable by a sintering method as described in any one of claims 24 to 27.

54. Use according to any one of claims 51 to 53, wherein the sintered porous silicon-containing particles are as defined in any one of claims 28 to 36.
